(19) United States
(12) Patent Application Publication
(10) Pub. No.: US 2023/0385788 A1
(43) Pub. Date: Nov. 30, 2023

(54) SYSTEM AND METHOD FOR PROVIDING ADDITIONAL FUNCTIONALITY FOR NON-FUNGIBLE TOKENS

(71) Applicant: Fandex, Inc., Durham, NC (US)

(72) Inventors: Matthew D'Alessandro, Durham, NC (US); Nicholas Canova, Durham, NC (US); Edward Tiryakian, Durham, NC (US)

(21) Appl. No.: 18/137,788

(22) Filed: Apr. 21, 2023

Related U.S. Application Data
(60) Provisional application No. 63/333,785, filed on Apr. 22, 2022.

(51) Int. Cl. G06Q 20/10; G06Q 20/38

(52) U.S. Cl. CPC G06Q 20/10; G06Q 20/389; G06Q 20/3829

(57) ABSTRACT

Disclosed is a method for execution by a server for providing additional functionality for NFTs (Non-Fungible Tokens). The method involves interacting with a blockchain network having NFTs, interacting with client computing devices, and for each NFT, facilitating ownership transfer of the NFT based on the interacting with the client computing devices. In accordance with an embodiment of the disclosure, the method also involves, for each NFT, facilitating addition and subtraction of at least one value unit tied to the NFT based on the interacting with the client computing devices. Such additional functionality can provide for more excitement and encourage more transactions thereby resulting in greater liquidity.

### PRIORITY CLAIM

This patent application claims priority to U.S. Provisional Application No. 63/333,785 filed on Apr. 22, 2022, the disclosure of which is incorporated herein by reference in its entirety.

### FIELD OF THE DISCLOSURE

This disclosure relates to blockchain systems, and more particularly to blockchain systems supporting NFTs (Non-Fungible Tokens).

### BACKGROUND

An NFT is a non-interchangeable unit of data stored on a blockchain and may be associated with digital files such as photos, videos, and/or audio for example. NFTs are uniquely identifiable and therefore differ from blockchain cryptocurrencies such as Bitcoin for example. Some NFTs may depict sports players and/or sports teams. Other NFTs may depict other things or nothing at all.

It is relatively commonplace to purchase an NFT for investment purposes. For example, an investor may purchase an NFT that depicts a sports player, and although such purchase could be motivated in part by being a fan of the sports player, the investor is likely motivated by a prospect of being able to sell the NFT at some later time for a profit. However, such investment activity is not very exciting and generally involves very few ownership transfers thereby resulting in low liquidity for the NFTs.

It is desirable to improve upon conventional approaches by employing technology to eliminate or mitigate some or all of the aforementioned shortcomings.

### SUMMARY OF THE DISCLOSURE

Disclosed is a method for execution by a server for providing additional functionality for NFTs. The method involves interacting with a blockchain network having NFTs, interacting with client computing devices, and for each NFT, facilitating ownership transfer of the NFT based on the interacting with the client computing devices.

In accordance with an embodiment of the disclosure, the method also involves, for each NFT, facilitating addition and subtraction of at least one value unit tied to the NFT based on the interacting with the client computing devices. Such additional functionality can provide for more excitement and encourage more transactions thereby resulting in greater liquidity for the NFTs.

In some implementations, for at least a first subset of the NFTs, the at least one value unit includes shares associated with the NFT. In some implementations, for each NFT of the first subset, the NFT is tied to media content that depicts a sports team, and the shares associated with the NFT are virtual shares of that sports team.

In some implementations, for at least a second subset of the NFTs, the at least one value unit includes an offering associated with the NFT. In some implementations, for each NFT of the second subset, the NFT is tied to media content that depicts a sports player, and the offering associated with the NFT is an offering from that sports player.

In some implementations, the server facilitates a fractional ownership transfer of at least some of the NFTs based on the interacting with the client computing devices.

In some implementations, the server hosts an NFT marketplace configured to enable the client computing devices to request NFT transactions including buy, sell and swap. In some implementations, for each NFT, the server maintains a book value for the NFT, wherein the NFT transactions facilitated by the NFT marketplace further includes redemption for the book value.

Also disclosed is a non-transitory computer readable medium having recorded thereon statements and instructions that, when executed by a processor of a server, configure the server to implement the method summarized above.

Also disclosed is a server configured to provide additional functionality for NFTs. The server has a network adapter, and NFT functionality circuitry coupled to the network adapter and configured to implement the method summarized above.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of a blockchain system having a server coupled to a blockchain network and a plurality of client computing devices via a network;

FIG. 2 is a flowchart of a method for execution by the server of FIG. 1 for providing additional functionality for NFTs;

FIGS. 3 to 5 are schematics of example NFTs that may be provided by the blockchain system of FIG. 1; and

FIGS. 6 to 8 are schematics of an example GUI (Graphic User Interface) of an NFT marketplace that may be hosted by the server of FIG. 1.

### DETAILED DESCRIPTION OF EMBODIMENTS

Generally, this disclosure enables various technologies for providing additional functionality for Non-Fungible Tokens, which address the technical problem explained above. It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

### Blockchain System

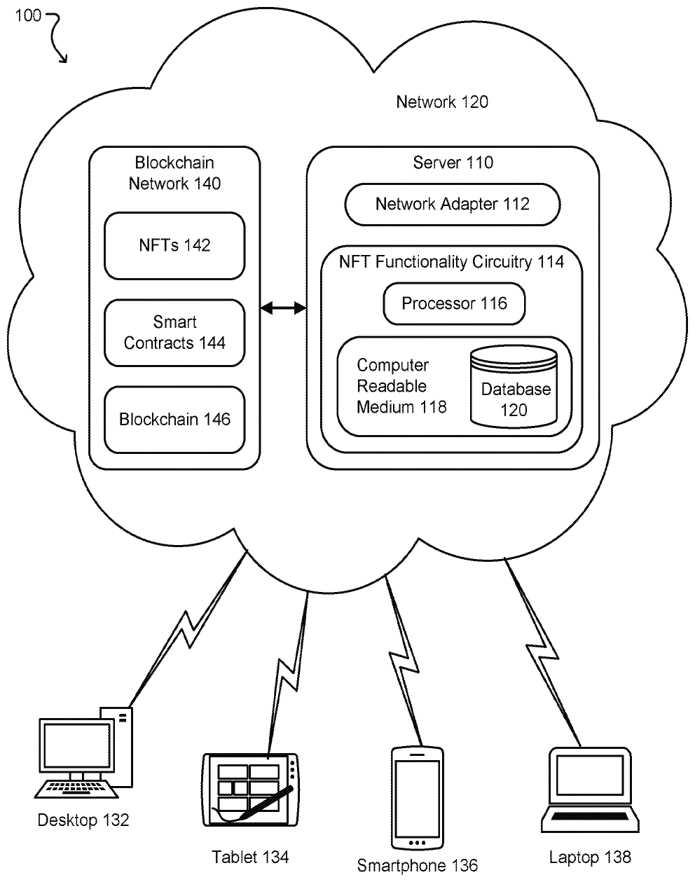

Referring now to FIG. 1, shown is a block diagram of a blockchain system 100 having a server 110 coupled to a blockchain network 140 and a plurality of client computing devices 132, 134, 136, 138 via a network 120. The client computing devices 132, 134, 136, 138 are coupled indirectly to the blockchain network 140 via the server 110, which is considered centralized because it is not part of the blockchain network 140. However, the client computing devices 132, 134, 136, 138 can additionally be coupled directly to the blockchain network 140 to facilitate peer to peer transactions among the client computing devices 132, 134, 136, 138 in a decentralized manner over the blockchain network 140. The blockchain system 100 can have other components as well, but these are not shown for simplicity.

The blockchain network 140 is composed of numerous computing nodes (not shown) that may be in disparate locations around the world, but these computing nodes are not shown for simplicity. The blockchain network 140 has NFTs 142 and/or other cryptographic tokens, smart contracts 144, and a blockchain 146 which is a form of digital ledger for encoding transactions such as ownership transfers of the NFTs 142 and/or execution results of the smart contracts 144. The blockchain network 140 may have additional components that are not shown for simplicity. The numerous computing nodes (not shown) of the blockchain network 140 collectively provide a computing environment for executing the smart contracts 144 and for verifying execution results and ownership transfers of the NFTs 142 prior to encoding the execution results and ownership transfers into the blockchain 146.

Each NFT 142 is a non-interchangeable unit of data stored on the blockchain 146 and may be associated with digital files such as photos, videos, and/or audio for example. The digital files are normally stored off the blockchain 146, for example on the server 110, such that each NFT 142 stored on the blockchain 146 includes a link to a digital file tied to the NFT 142, although other implementations are possible in which the digital files are actually stored on the blockchain 146. Each NFT 142 is uniquely identifiable and therefore differs from blockchain cryptocurrencies such as Bitcoin for example. In some implementations, the blockchain network 140 enables ownership transfer of the NFTs 142 using the smart contracts 144. For example, information regarding ownership transfer can be defined in the smart contracts 144, and upon execution of the smart contracts 144, an execution result can be encoded into the blockchain 146. In other implementations, ownership transfer is possible without the smart contracts 144, depending on the blockchain network 140. Parties to the ownership transfer can interact with the blockchain network 140 via the client computing devices 132, 134, 136, 138.

The server 110 has a network adapter 112 configured to communicate with the blockchain network 140 and the client computing devices 132, 134, 136, 138 over the network 120. The server 110 also has NFT functionality circuitry 114 and may have additional components that are not shown for simplicity. Although the server 110 is shown as a single node, it is noted that it can include multiple nodes, for example a first node (not shown) interfacing with the blockchain network 140 and a second node (not shown) acting as a conduit between the client computing devices 132, 134, 136, 138 and the first node. In general, the server 110 includes one or more nodes that can collectively provide for the functionality of the server 110 as described herein.

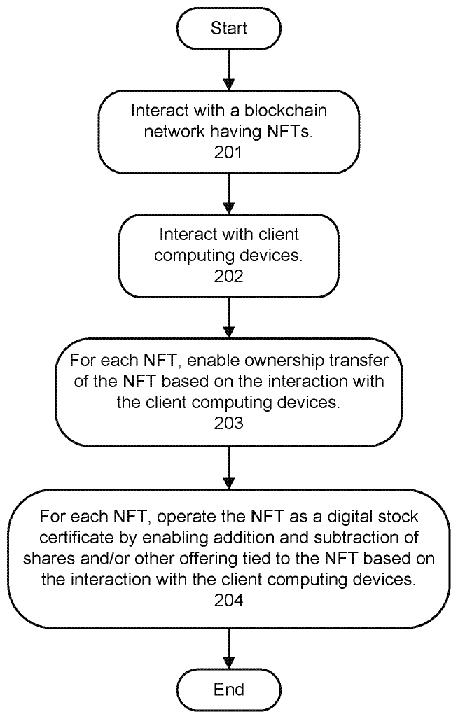

As noted above, it is relatively commonplace to purchase an NFT as an investment, but such investment activity is not very exciting and generally involves very few ownership transfers thereby resulting in low liquidity. In accordance with an embodiment of the disclosure, the NFT functionality circuitry 114 of the server 110 operates to provide additional functionality for the NFTs 142, with a view that the additional functionality can provide for more excitement and encourage more transactions thereby resulting in greater liquidity. Such operation will be described below with reference to FIG. 2, which is a flowchart of a method for execution by the server 110 for providing additional functionality for the NFTs 142. Although the method of FIG. 2 is described below with reference to the server 110 in the blockchain system 100 shown in FIG. 1, it is to be understood that the method of FIG. 2 is applicable to other blockchain systems. In general, the method of FIG. 2 is applicable to the server 110 in any appropriately configured blockchain system.

At step 201, the server 110 interacts with the blockchain network 140 having the NFTs 142. At step 202, the server 110 interacts with the client computing devices 132, 134, 136, 138. Such interaction can include receiving requests for NFT transactions involving the NFTs 142 such as buy, sell, swap, and redeem. Such NFT transactions generally involve some sort of ownership transfer. At step 203, for each NFT 142, the server 110 facilitates ownership transfer of the NFT 142 based on the interaction with the client computing devices 132, 134, 136, 138.

In accordance with an embodiment of the disclosure, at step 204, for each NFT 142, the server 110 facilitates addition and subtraction of at least one value unit tied to the NFT 142 based on the interaction with the client computing devices 132, 134, 136, 138. The addition and subtraction of the at least one value unit is additional functionality for the NFTs 142. Such additional functionality can provide for more excitement and encourage more transactions thereby resulting in greater liquidity. There are many possibilities for this additional functionality as described below.

In some implementations, for at least a first subset of the NFTs 142, the at least one value unit includes shares associated with the NFT 142. In some implementations, for each NFT 142 of the first subset, the NFT 142 is tied to media content that depicts a sports team, and the shares associated with the NFT 142 are virtual shares of that sports team. Addition of the virtual shares to the NFT 142 can increase its value. Conversely, subtraction of the virtual shares from the NFT 142 can decrease its value.

As a specific example, an owner of a Boston Red Sox NFT can purchase virtual shares for the Boston Red Sox, and those virtual shares will be tied to the Boston Red Sox NFT thereby increasing its value. Conversely, the owner of the Boston Red Sox NFT can sell the virtual shares. In this way, embodiments of the disclosure enable an NFT to function like a digital stock certificate, such that virtual shares can be purchased and sold as may be desired.

In some implementations, for at least a second subset of the NFTs 142, the at least one value unit includes an offering associated with the NFT 142 other than shares. In some implementations, for each NFT 142 of the second subset, the NFT 142 is tied to media content that depicts a sports player, and the offering associated with the NFT 142 is an offering from that sports player. Addition of the offering to the NFT 142 can increase its value. Conversely, subtraction of the offering from the NFT 142 can decrease its value.

As a specific example, an offering from a sports player can be an offer by the sports player to go out to dinner with the owner of the NFT 142 in real life or some other real-life meeting. As another specific example, an offering from a sports player can be an autographed sports jersey. An offering can be decided by the sports player, and the NFT 142 with the offering being identified can be auctioned through an NFT marketplace hosted by the server 110. In some implementations, the sports player receives a portion of the sale from the auction (e.g., 50% or some other appropriate or negotiated portion) thereby motivating the sports player to participate in the NFT marketplace and provide offerings that they expect to result in large sales. In some implementations, upon the offering being used (e.g., the sports player goes out to dinner with the owner of the NFT 142), the offering is subtracted from the NFT 142, and the NFT 142 can then be redeemed at the marketplace. At this point, the sports player has an opportunity to “re-load” the NFT 142 with another offering ahead of another auction to sell the NFT 142 again. The process of adding and subtracting offers can be repeated many times with each time the sports player receiving their portion of the sales from the auctions.

In some implementations, the first subset of the NFTs 142 and the second subset of the NFTs 142 are mutually exclusive. This means that the NFTs 142 that can be loaded with virtual shares cannot be loaded with an offering from a sports player. In other implementations, the first subset of the NFTs 142 and the second subset of the NFTs 142 are not mutually exclusive. This means that some of the NFTs 142 can be loaded with virtual shares and offerings from a sports player.

For a given sports league, for example MLB (Major League Baseball), there can be a defined number of NFTs per sports team (e.g., 1000 NFTs per sports team) and a defined number of NFTs per sports player (e.g., 100 NFTs per sports player). Note that the number of NFTs is implementation specific. Also note that all NFTs are at least slightly different from one another. Such differences can include a serial number and perhaps additional differences as well.

In some implementations, for each NFT 142, the server 110 maintains an accounting of the at least one value unit (e.g., shares and/or other offering) in the database 120 of the server 110. In this way, the accounting of the at least one value unit can be done in a centralized manner. Additionally, or alternatively, for each NFT 142, the server 110 maintains an accounting of the at least one value unit in the blockchain network 140. In this way, the accounting of the at least one value unit can be done in a decentralized manner.

In some implementations, for each NFT 142, the server 100 maintains private keys for the NFT 142 on behalf of an owner of the NFT 142, and maintains an accounting of the ownership transfer in the database 120 of the server 110. In this way, the accounting of ownership transfer can be done in a centralized manner. Additionally, or alternatively, for each NFT 142, the server 100 can maintain an accounting of the ownership transfer in the blockchain network 140. In this way, the accounting of the ownership transfer can be done in a decentralized manner.

In some implementations, the server 110 facilitates a fractional ownership transfer of at least some of the NFTs 142 based on the interacting with the client computing devices 132, 134, 136, 138. For example, a 25% ownership of an NFT can be sold from an owner to a purchaser. Of course, whole ownership transfer (i.e., 100%) is also possible.

There are many ways in which fractional ownership can be implemented. In some implementations, each NFT 142 includes one or more data fields for keeping track of ownership transfers, including fractional transfers. The one or more data fields can be encoded on the blockchain 146. Thus, upon an ownership transfer of an NFT 142, the one or more data fields of that NFT 142 is updated and encoded in the blockchain 146. By identifying ownership transfers on the blockchain 146, ownership of each NFT 142, there is no reliance on the server 110 to keep track of ownership, and hence if the server 110 is ever upgraded or replaced, ownership of the NFTs 142 can be ensured by the blockchain 146.

In some implementations, the server 110 holds private keys for the NFTs 142 on behalf of the owners and uses the private keys to update the one or more data fields upon ownership transfer. Some degree of centralization (i.e., the server 110 holding and utilizing the private keys) could allow for an easier and more enjoyable experience for all participants, and enable the server 110 to facilitate fractional ownership transfers. In some implementations, the server 110 utilizes a smart contract 144 for each ownership transfer.

In some implementations, the server 110 can facilitate a swap involving a first set of at least one NFT 142 against a second set of at least one NFT 142. As a specific example, a Red Sox NFT can be bet against a Yankees NFT depending on a game or series. The swap can involve two NFTs 142 of equal value. Alternatively, it can involve two NFTs 142 of unequal value, such that a fractional share of the more valuable NFT 142 is bet against the other NFT 142. For example, if a first NFT 142 is valued at $20, and a second NFT 142 is valued at $5, it is possible for a 25% ownership of the first NFT to be bet against a 100% ownership of the second NFT 142. Multiple NFTs can be bet against multiple NFTs as well. Although a swap may be dependant on sporting outcome, it may not be considered to be gambling.

In some implementations, the server 110 hosts the NFT marketplace to provide a convenient way for the client computing devices 132, 134, 136, 138 to perform transactions such as buy, sell and/or swap. In some implementations, all of the NFTs 142 have a “book value”, which means they can be redeemed for the book value at the NFT marketplace. In some implementations, the NFT marketplace utilizes a web interface, in which case the server 110 can include a web server. Additionally, or alternatively, the server 110 includes an application server, and the client computing devices 132, 134, 136, 138 are able to interact with the server 110 via applications that are downloaded and executed locally on the computing devices 132, 134, 136, 138. Other implementations are possible.

There are many possibilities for the blockchain network 140. In some implementations, the blockchain network 140 is an Ethereum network. However, there are many other possibilities, including a Solana network, a Tezos network, a Worldwide Asset eXchange Blockchain network, a Hive blockchain network, a Polkadot network, and a Cardano network to name a few.

There are many possibilities for the client computing devices 132, 134, 136, 138. The client computing devices 132, 134, 136, 138 can for example include a desktop computer 132, a tablet computer 134, a smartphone 136, a laptop 138, and/or any other appropriate client computing device. The client computing devices 132, 134, 136, 138 can communicate with the server 110 using wireless connections as depicted and/or wired connections. Although only four client computing devices 132, 134, 136, 138 are depicted, it is to be understood that there can be more or less than four computing devices 132, 134, 136, 138. Typically, there would be much more than four computing devices 132, 134, 136, 138.

There are many possibilities for the network 120. The network 120 can include several different networks even though such details are not shown for simplicity. For example, the network 120 can include a RAN (Radio Access Network) for communicating with wireless stations and the Internet for communicating with numerous other computing devices. The network 120 can have other components as well, but these details are not shown for simplicity.

There are many possibilities for the server 110. In some implementations, the server 110 includes a web server and the data sent by the server 110 includes web content for a web browser. Additionally, or alternatively, the server 110 can include an application server and the graphic data includes content for a mobile app. Other implementations are possible.

There are many possibilities for the network adapter 112 of the server 110. In some implementations, the network adapter 112 is a single network adapter 112. In other implementations, the network adapter 112 includes multiple network adapters, for example a first network adapter for communicating with the one or more client computing devices 132, 134, 136, 138, and a second network adapter for communicating with the blockchain network 140. Both wireless and wired network adapters are possible. Any suitable network adapter that can communicate via the network 120 is possible.

There are many possibilities for the NFT functionality circuitry 114 of the server 110. In some implementations, the NFT functionality circuitry 114 includes a processor 116 that executes software, which can stem from a computer readable medium 118. In some implementations, the computer readable medium 118 also has a database 120 for storing NFT information in a centralized manner as described above. However, other implementations, besides software implementations, are possible and are within the scope of this disclosure. It is noted that other implementations can include additional or alternative hardware components, such as any appropriately configured FPGA (Field-Programmable Gate Array), ASIC (Application-Specific Integrated Circuit), and/or microcontroller, for example. More generally, the NFT functionality circuitry 114 of the server 110 can be implemented with any suitable combination of hardware, software and/or firmware.

According to another embodiment of the disclosure, there is provided a non-transitory computer readable medium having recorded thereon statements and instructions that, when executed by the processor 116 of the server 110, implement a method as described herein. The non-transitory computer readable medium can be the computer readable medium 118 of the server 110 shown in FIG. 1, or some other non-transitory computer readable medium. The non-transitory computer readable medium can for example include an SSD (Solid State Drive), a hard disk drive, a CD (Compact Disc), a DVD (Digital Video Disc), a BD (Blu-ray Disc), a memory stick, or any appropriate combination thereof.

### Example NFTs & Marketplace

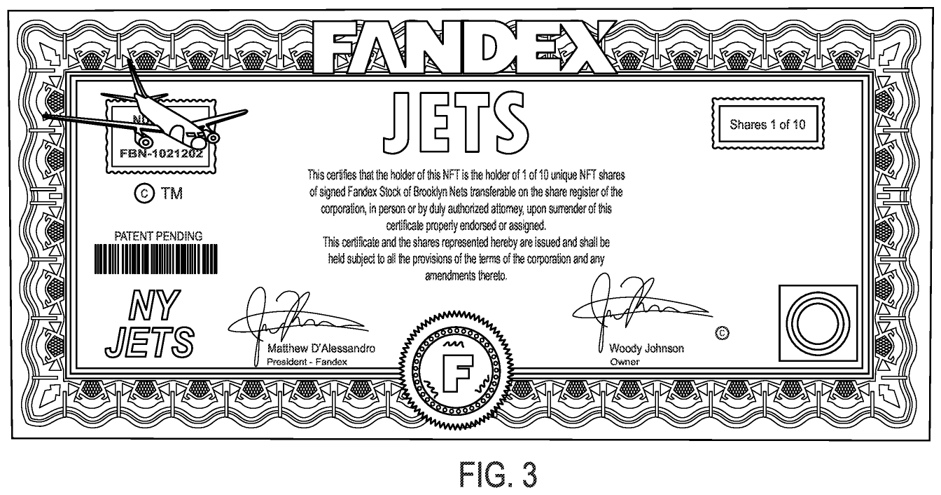

Referring now to FIGS. 3 to 5, shown are schematics of example NFTs that may be provided by the blockchain system of FIG. 1. It is to be understood that the NFTs are very specific and are provided merely as an example. In some implementations, all NFTs are crypto backed with a token and involve multiple levels. For example, there can be three levels including a premium model.

Referring first to FIG. 3, shown is a schematics of an example Level 1 NFT. It includes a 3D certificate with a unique 3D team logos, but no player adaptation. This has a “book value” and shares can be loaded for the purpose of swapping. In some implementations, the 3D certificate has some rotational movement and other animation such as a jet flying across the 3D certificate. Each NFT has a unique serial number and may have other unique features as well.

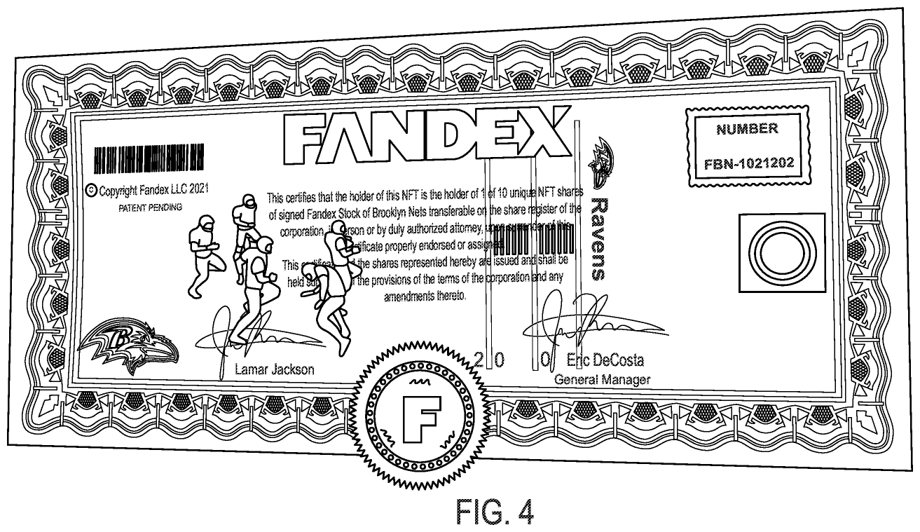

Referring now to FIG. 4, shown is a schematics of an example Level 2 NFT. It includes a player's likeness as a limited run of certificates. It can also be loaded with shares and a “book value” still applies but the player receives proceeds for their signature. In some implementations, the 3D certificate has some rotational movement and other animation such as players moving across the 3D certificate. Each NFT has a unique serial number and may have other unique features as well.

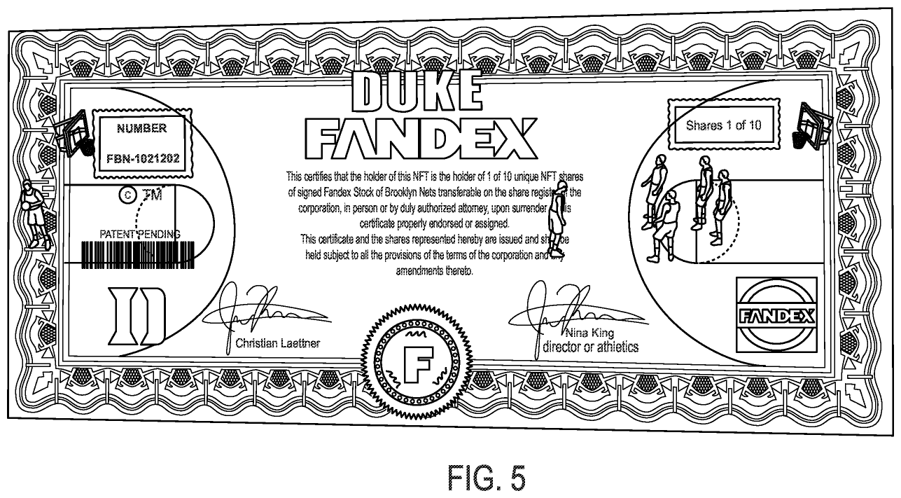

Referring now to FIG. 5, shown is a schematics of an example Level 3 NFT. A book value applies but more like a celebrity auction with special features unique to the player: digital DNA, signed Merch, special access to player content and goods, all depending on the player. Limited run and bidding in place which player receives. Crypto token backed so player receives part of every transaction. In some implementations, the 3D certificate has some rotational movement and other animation such as players moving across the 3D certificate. Each NFT has a unique serial number and may have other unique features as well.

In some implementations, at least some of the NFTs have prices that are determined by algorithms. In some implementations, the Level 1 NFTs have prices that are determined by the algorithms, while Level 2 NFTs and Level 3 NFTs have prices that are determined based on supply and demand (e.g., bidding in auctions at an NFT marketplace). In some implementations, the algorithms determine prices for the Level 1 NFTs and any associate shares based on an algorithm that assess performance (e.g., past, current and/or expected future performance) of the sports teams depicted by the NFTs. In some implementations, the algorithms operate with real-time pricing, 24/7/365 in season and out of season. Details of example pricing algorithms are provided below.

In some implementations, the NFTs and/or associated offerings could be exchanged for goods/services offered by partners who can in turn sell the same back to the NFT marketplace. Ownership of an NFT and/or its associated offerings could be verified on the blockchain 146 before the exchange for goods/services. The partners could for example include online sellers such as Stubhub, Inc. or Fanatics Inc. Additional and alternative partnerships are possible.

The additional functionality described herein enables a free to play, “game of skill”, virtual stock exchange with numerous users. Here are examples of how the certificates may be used:
Buy a certificate and load shares of teams. As share prices change, the NFT can increase or decrease in value.
Swap certificates in the marketplace based on outcomes of sporting events. A Red Sox NFT versus a Yankees NFT depending on a game or series.
Bid on a player's NFT and receive the rewards attached: tickets to a game, a ride in the player's car, signed merchandise etc.
Collect NFTs as the limited collectable that they are, unique to the NFT Sports Factory.
“Play to earn”—as the certificate gains in value, use premium for tickets (Stubhub Inc. partnership), merchandise (Fanatics Inc. partnership), etc.

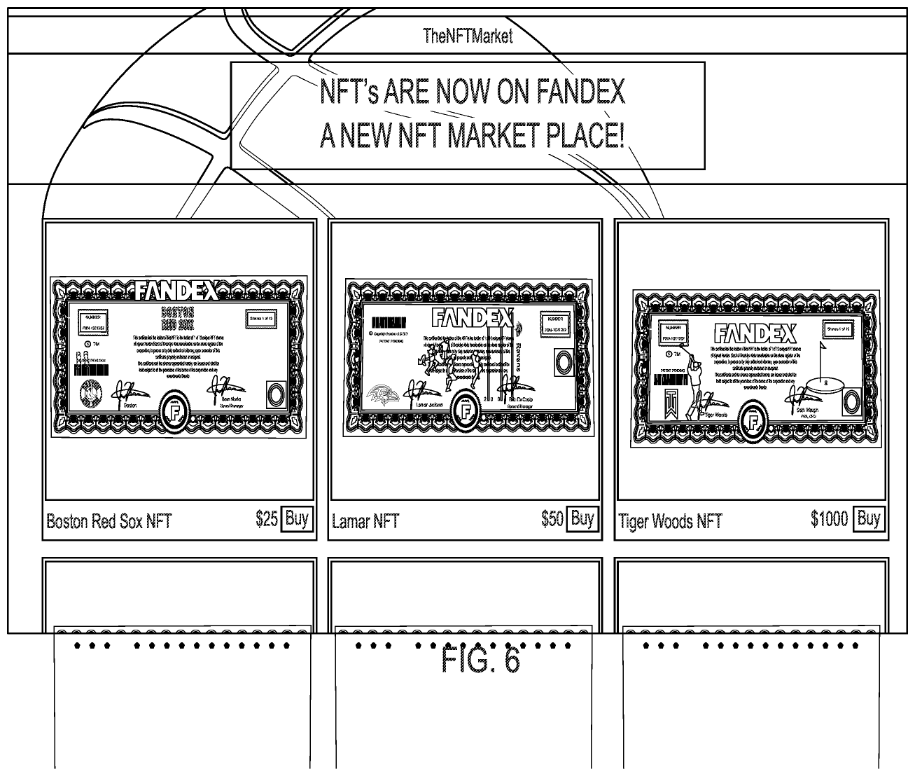

Referring now to FIGS. 6 to 8, shown are schematics of example GUIs of an NFT marketplace that may be hosted by the server of FIG. 1. It is to be understood that the GUIs are very specific and are provided merely as examples.

Referring first to FIG. 6, shown is an example GUI of an NFT marketplace that could be viewed by the client computing devices 132, 134, 136, 138 when viewing the NFT marketplace. Purchases can be made through the NFT marketplace.

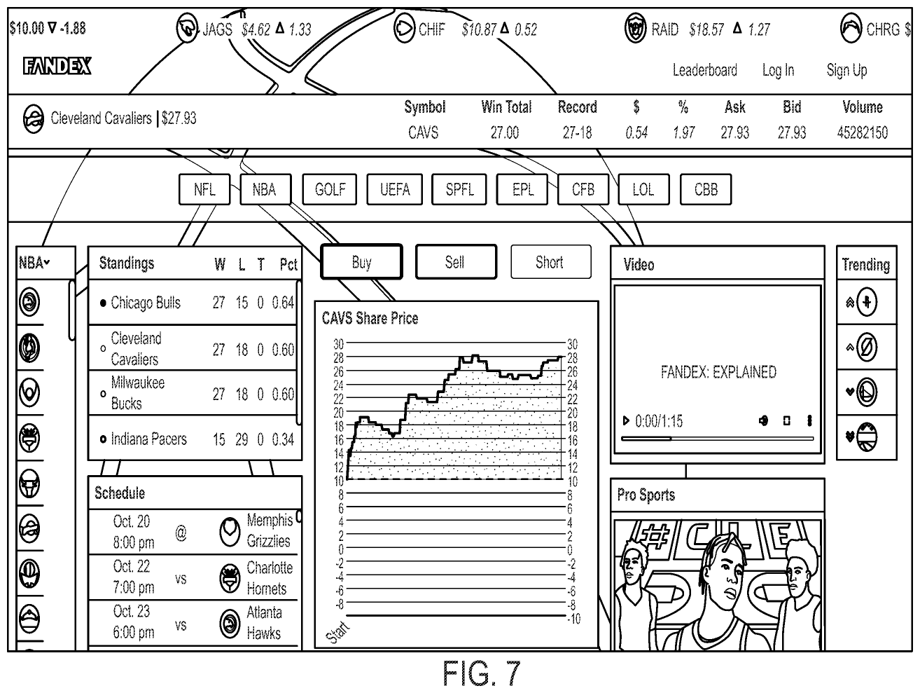

Referring now to FIG. 7, shown is an example GUI of an NFT share price over time that could be viewed by the client computing devices 132, 134, 136, 138 when tracking price of an NFT.

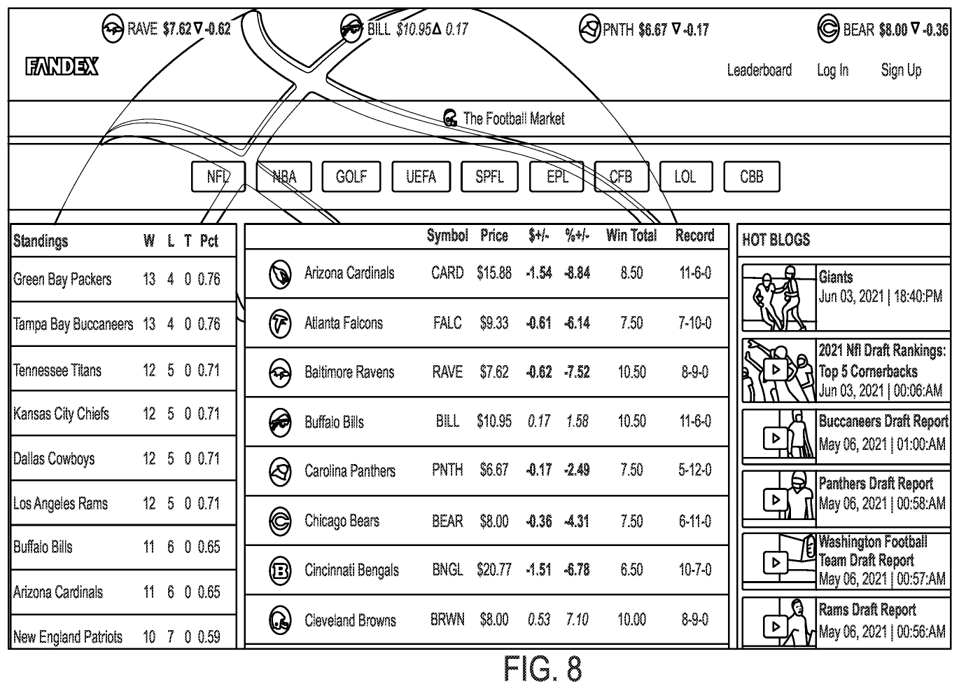

Referring now to FIG. 8, shown is an example GUI of NFT share prices that could be viewed by the client computing devices 132, 134, 136, 138 when viewing prices of several NFTs.

### Example Pricing Algorithms

As noted above, pricing algorithms can be employed to determine prices of at least some of the NFTs and any associated shares. Example pricing algorithms are provided in this section. It is to be understood that these pricing algorithms are very specific are provided merely for exemplary purposes. While reference is made to specific sporting leagues, it is to be understood that the pricing algorithms are generally applicable to any sporting league.

### (1) IGWP (In Game Win Probability) Model For Computing Win Totals & Share Prices In Real-Time

For example, NFL (National Football League), NBA (National Basketball Association), CBB (College Basketball) and UEFA (Union of European Football Associations) European Championship 2021 exchanges may use in-game win-probability IGWP algorithms to power real-time, in-game updates to win totals and share prices. The combination of IGWP algorithms, along with full season win total algorithms, results in a collective model that is able to update team share prices in real-time during sporting events.

The IGWP algorithms may be based on game points scored being well approximated by normal distributions, based on probability's CLT (Central Limit Theorem), assuming that enough time for a remaining score difference at any time has an approximate normal distribution. For example, a standard deviation in the NBA is roughly 12 points per game. If t minutes remain, the standard deviation of the score differential after that would be 12 times the square root of (t/48). Therefore, 12 is the standard deviation at the start of the game (t=48 minutes), and this drops to 0 at the game's end (t=0minutes). The Normal approximation can become inaccurate over the last few minutes of a game due to sample size limitations, and because game scoring rates change at the end of close games.

The IGWP algorithms may have certain fundamental inputs. However, as IGWP models are utilized over a broader array of leagues, these inputs will vary from league-to-league based on the available data. The following inputs may be utilized to compute a live in-game win-probability for the NFL and NBA:
The current score between teams
The pre-game team ratings
The time remaining in the game
Which team has possession of the ball
Other added features for the NFL:
   Down and Distance
   Timeouts Remaining
      A statistical approach and a second approach are described below.

For the statistical approach, the NBA algorithm may assume that the probability that a favored team wins with t minutes remaining depends on the following Z-score, which accounts for:
t: 0-48 minutes remaining in a game
(t/48): % of the game completed
S: point-spread of the game before the game starts
S(t): S*(t/48): the proportional point-spread for remaining play
L(t): the favored team's lead with t minutes remaining
σ: the standard deviation in points per game

$$Z = \frac{L ( t ) \pm 0.5 + ( \frac{t}{48} ) S}{σ \sqrt{\frac{t}{48}}}$$

The Z-score can then be utilized to identify the favored team's probability of winning the game (assuming the normal distribution applies to the score differential throughout the game) as:

IGWP=P(N(0,1)<Z)

From the probability of winning the game, the prices of NFTs and associated shares (e.g., for Level 1 NFT) can be calculated.

As an example of the statistical approach, with 20 minutes remaining (t=20), a team that was a 4-point pre-game favorite (S=4) is in possession of the ball with a 12-point lead (L(t)=12). Then the Z-score for our in-game win probability equation and probability of winning are:

$$Z = \frac{L ( t ) + 0.5 + ( \frac{t}{48} ) S}{σ \sqrt{\frac{t}{48}}} = \frac{12 + 0.5 + ( \frac{20}{48} ) * 4}{12 \sqrt{\frac{20}{48}}} = 1 \text{.83}$$

$$IGWP = P ( N ( 0 , 1 ) < 1.83 ) = 85.8 \%$$

Regarding the second algorithm, the second algorithm can switch from a normal distribution model to a logistic regression model to predict live in-game win-probabilities. For example, for the NBA model, 48 multiple logistic regressions may be run of the favored team winning, one model for each of the 48 minutes remaining in a game. Each logistic regression can predict 0 or 1, the indicator of whether the favored team won.

Combinations of the normal distribution model and the logistic regression model are also possible. The prices of NFTs and associated shares (e.g., for Level 1 NFT) can be calculated in a similar manner.

### (2) Use Case of Individual Player Ratings to Predict Team-Season Win Totals

A win prediction model that utilizes individual player offensive & defensive plus-minus metrics (the player ratings) may also be utilized, as well as the following additional features:
Individual player minutes played and projected minutes played
Trades of players between teams
Projected player ratings of drafted rookies using our rookie projection system
Injuries and suspensions of players for a determined period of time.

As an example, a fictitious team below of 8 players, each projected to play a certain number of minutes, and each with offensive & defensive player ratings:

| Players | Minutes | Off+/− | Def+/− |
|---|---|---|---|
| Player 1 | 45 | 3.6 | 0.7 |
| Player 2 | 40 | 1.7 | 1.6 |
| Player 3 | 38 | 0.8 | 0.4 |
| Player 4 | 31 | −0.7 | −1.1 |
| Player 5 | 29 | −0.2 | 1.3 |
| Player 6 | 24 | 0.4 | −1.9 |
| Player 7 | 19 | 1.1 | −2.5 |
| Player 8 | 14 | 0.3 | 0.4 |

First, a minute-weighted average of the player ratings including OPM (Offensive Plus/Minus) and DPM (Defensive Plus/Minus) may be taken to get a measure of team efficiency:

$$mwO P M = {\sum }_{i = 1}^{n} ( \frac{min {s}_{i}}{48} ) * O P {M}_{i} = 5 \text{.575}$$

$$mwD P M = {\sum }_{i = 1}^{n} ( \frac{min {s}_{i}}{48} ) * D P {M}_{i} = 0.558$$

Next, the team's minute-weighted plus-minus values may be combined with the league-average pace and scoring in order to compute the team's projected scoring. Assuming league-average pace of 104 points per game, and league-average scoring is 110 points per game, then the fictitious team in this example would project to:

$$projScored = lgScoring + ( mwO P M * ( \frac{l g P a c e}{100} ) ) = 115.8$$

$$projAgainst = lgScoring - ( mwD P M * ( \frac{l g P a c e}{100} ) ) = 109.4$$

Next, Pythagorean win probabilities may be utilized to project win totals. Assuming the fictitious team in this example is in the NBA, then their projected scoring would convert into the following win projections:

$$win \% = \frac{{projScored}^{14}}{{projScored}^{14} + {projAgainst}^{14}} = \frac{115 . {8}^{14}}{115 . {8}^{14} + 109 . {4}^{14}} = 68.9 \%$$

Last, the product between a team's win % and their remaining games is taken and summed with a team's current wins to compute a live prediction of win totals of a team between a team's win probabilities to project win totals. Assuming the fictitious team is in the NBA, then their projected scoring would convert into the following win projections:

winTotal=currWins+(win %*gamesRemaining)

Utilizing the above series of equations, in addition to the additional computations and adjustments made to account for (a) team strength of remaining opponents, (b) player trades, (c) player injuries, (d) player suspensions, (e) free agency, and (f) the draft, allows the exchanges to be powered.

In particular, the prices of NFTs and associated shares (e.g., for Level 1 NFT) can be calculated. As a bottom-up approach driven by the ratings of players themselves, as the exchange is able to be operated year-round, handling player actions in a manner that drives share price activity in a 365-day year-round manner.

### (3) Approach For Creating a Players Exchange with Real-Time Movement of Share Prices

According to an embodiment with NBA basketball players, an algorithm may be used to generate a Players Exchange that computes and updates share prices for individual players in real-time as games are played.

For example, NBA players accrue statistics each game over a variety of categories including:
Minutes played
2-pointers made and 2-point percentage
3-pointers made and 3-point percentage
Free throws made and FT percentage
Points
Offensive and Defensive Rebounds
Assists
Steals
Blocks
Turnovers

Prior to the start of an NBA season, a model is run to project the full-season total statistical values for these stats for all players. These stat projections are referred to as preseason predictions. At any given point in the season, a second model may be run that computes an up-to-the-minute projection of these full-season total stats values for each player, which are referred to as current predictions. If a game is live, the in-game predictions model is run to project remaining stats accumulated in the game.

Incorporating the outputs from all three prediction models, an expectations score for each player may be computed that can be directly translated into a share price. Simply put, as players outperform their preseason predictions, share prices increase. Players whose current predictions are lower relative to their preseason predictions will see their share price decrease.

There are many possibilities for the preseason predictions. Some possibilities include utilizing various statistical approaches, including:
K-NN (k-nearest neighbors)—for each player and statistical metric to be predicted, a K-NN algorithm may be utilized to identify comparable players and analyze their past performance for the predictions. Weighted values may be assigned to each player derived from statistical similarity scores, and computed across all comparable players their percentage change in each statistical metric year-to-year. A weighted-average percentage change may then be computed for each statistic.
age & minutes curve projected metrics may be utilized to predict full-season stats utilizing a player's age, a weighted-average of their previous-3-years statistics, and a projection of their future minutes played.

There are many possibilities for the current predictions. For up-to-date predictions on each player, an approach that predicts player stats to be accrued over all remaining games may be utilized, which takes into account the player's stats up to that point in the season, as well as the remaining opponents and their team statistical profiles.

For example, if a player is playing in an active game, a third model may be utilized for in-game predictions. There are many possibilities for the in-game prediction. Derived from (a) the player's current stats in the active game, as well as (b) the player's expected performance over the remainder of the game, the players expected performance (additional statistics accrued) in the game may be projected. The player's expected performance over the remainder of the active game takes into account the amount of time remaining, as well as the player's opponent and that team's statistical profile.

### (4) Utilization of Simulation Model to Computing Preseason Team Win-Prediction

It is further understood that two NBA teams (Team A and Team B) each predicted to win 41 regular season games may not be of the same overall strength. For example, Team A could be a Western Conference team, and have a much more difficult schedule than Team B, which is located in an inferior Eastern Conference. This difference in team strengths isn't captured by preseason win totals, but can be reflected in any Team Ratings that are calculated.

Preseason Team Ratings that combine a collection of pre-season win total predictions with a simulation model that can run through the NBA season at a very high frequency can be utilized. By utilizing the collection of pre-season win total predictions, the correct Team Ratings can be calculated by simulating the season 10,000 times and solving for the Implied Team Ratings determined for each team to lead to their projected win totals.

For example, the model will know that Team A is a stronger team than Team B, as a higher Team Rating is statistically provided for Team A to win 41 games in the Western Conference compared to Team B winning 41 games in the Eastern Conference.

For example, for the 2018-2019 NBA Season, the Washington Wizards and Los Angeles Lakers were both predicted to win 48 games. Due to the differences in strength of schedule between the two teams, simulation model described herein computed a 1573 team rating for the Lakers and a 1556 team rating for the Wizards. For teams with an identical strength of schedule, a difference of 17 team rating points is worth nearly 2 additional wins over an 82-game regular season.

### (5) Use Case of Team ELO Ratings to Predict Win Totals

The ELO Rating System is a method for calculating the relative skill levels of players in games. Initially invented for the game of chess, the system has been used in a variety of games, including team sports such as baseball and football. According to an embodiment of the invention, the ELO ratings system may be utilized to compute share prices and power our exchanges, adjusting for various sport-specific factors, including but not limited to:
The relative strength of home court advantage in each sports league
The handling of a team's margin of victory when updating ELO ratings.
Individual player impacts to team ELO ratings following trades, injuries and suspensions.

### (6) Other Comments on the Algorithms and Approaches

According to another embodiment, a points-prediction model for the LOL (League of Legends) 2021 Worlds Tournament is provided. LOL Worlds has a unique structure, and the model described herein is able, at any given point in the tournament, to simulate the remainder of the tournament and predict each team's end-of-tournament point totals.

According to another embodiment, a player pricing model is provided for PGA (Professional Golfers' Association) players utilizing the PGA's tracking of Official Money, and incorporated player world golf rankings and tournament purse sizes as inputs into predictions for how much additional money each PGA tour golfer will earn over the course of the season.

According to another embodiment, regarding NBA Player's Stock Market, daily prediction across a plurality (e.g., dozen) of different player stats is utilized to create over/under achieving scores that become share prices.

According to another embodiment, Euro 2021 and March Madness models described herein may both feature tournament simulations and live in-game pricing via the IGWP models described above. Share prices are updating live for teams in these tournaments as the games are played and the score (and live win probabilities) update.

Numerous modifications and variations of the present disclosure are possible in light of the above teachings. It is therefore to be understood that within the scope of the appended claims, the disclosure may be practised otherwise than as specifically described herein.

We claim:

1. A method for execution by a server for providing additional functionality for NFTs (Non-Fungible Tokens), comprising:
interacting with a blockchain network having a plurality of NFTs;
interacting with a plurality of client computing devices;
for each NFT, facilitating ownership transfer of the NFT based on the interacting with the client computing devices; and
for each NFT, facilitating addition and subtraction of at least one value unit tied to the NFT based on the interacting with the client computing devices.

2. The method of claim 1, wherein, for at least a first subset of the NFTs, the at least one value unit comprises shares associated with the NFT.

3. The method of claim 2, wherein, for each NFT of the first subset, the NFT is tied to media content that depicts a sports team, and the shares associated with the NFT are virtual shares of that sports team.

4. The method of claim 3, further comprising:
for each NFT of the first subset, determining a price of the NFT and any shares associated with the NFT in real-time based on at least one algorithm that assess performance of the sports team depicted by the NFT.

5. The method of claim 4, wherein, for at least a second subset of the NFTs, the at least one value unit comprises an offering associated with the NFT.

6. The method of claim 5, wherein, for each NFT of the second subset, the NFT is tied to media content that depicts a sports player, and the offering associated with the NFT is an offering from that sports player.

7. The method of claim 6, further comprising:
for each NFT of the second subset, determining a price of the NFT and the offering associated with the NFT based on supply and demand for the NFT and the offering associated with the NFT.

8. The method of claim 7, comprising:
for each NFT, maintaining an accounting of the at least one value unit in a database of the server.

9. The method of claim 8, comprising:
for each NFT, maintaining an accounting of the at least one value unit in the blockchain network.

10. The method of claim 9, wherein, for each NFT, facilitating ownership transfer of the NFT comprises:
maintaining private keys for the NFT on behalf of an owner of the NFT; and
maintaining an accounting of the ownership transfer in a database of the server.

11. The method of claim 10, wherein, for each NFT, facilitating ownership transfer of the NFT comprises:
maintaining an accounting of the ownership transfer in the blockchain network.

12. The method of claim 11, wherein facilitating ownership transfer comprises:
facilitating a fractional ownership transfer of at least some of the NFTs based on the interacting with the client computing devices by enabling fractional ownership transfers to be indicated in one or more data fields of those NFTs.

13. The method of claim 12, wherein facilitating ownership transfer comprises:
facilitating a swap involving a first set of the NFTs against a second set of the NFTs based on a sporting outcome in accordance with the interacting with the client computing devices.

14. The method of claim 13, wherein the swap involves a fractional ownership bet of one or more of the NFTs of the first set and/or the second set.

15. The method of claim 14, further comprising:
hosting an NFT marketplace configured to enable the client computing devices to request NFT transactions comprising buy, sell and swap.

16. The method of claim 15, further comprising:
for each NFT, maintaining a book value for the NFT;
wherein the NFT transactions facilitated by the NFT marketplace further comprise redemption for the book value.

17. A non-transitory computer readable medium having recorded thereon statements and instructions that, when executed by a processor of a server, configure the server to implement the method of claim 1.

18. A server configured to provide additional functionality for NFTs (Non-Fungible Tokens), comprising:
a network adapter; and
NFT functionality circuitry coupled to the network adapter and configured to implement the method of claim 1.

19. The server of claim 18, wherein:
the NFT functionality circuitry comprises a processor; and
the server further comprises a non-transitory computer readable medium having recorded thereon statements and instructions that, when executed by the processor, configures the processor as the NFT functionality circuitry.

20. The server of claim 19, wherein the non-transitory computer readable medium comprises a database for storing NFT information in a centralized manner.
